(19) United States
(12) Patent Application Publication
(10) Pub. No.: US 2017/0236009 A1
(43) Pub. Date: Aug. 17, 2017

(54) AUTOMATED CAMERA STITCHING

(71) Applicant: Vivint, Inc., Provo, UT (US)

(72) Inventors: Michelle Zundel, Draper, UT (US); Michael D. Child, Lehi, UT (US)

(21) Appl. No.: 15/587,221

(22) Filed: May 4, 2017

Related U.S. Application Data
(63) Continuation-in-part of application No. 14/264,728, filed on Apr. 29, 2014.

(51) Int. Cl. G06K 9/00; G06T 11/60; H04N 7/18; G06T 7/246; G06K 9/62

(52) U.S. Cl. CPC G06K 9/00765; G06K 9/00771; G06T 7/248; G06K 9/6202; H04N 7/181; G06T 11/60; G06T 2207/30252; G06T 2207/10016; G06T 2207/10004; G06T 2207/30232

(57) ABSTRACT

A method for security and/or automation systems is described. In one embodiment, the method may include detecting, via a first camera at a premises, an object, identifying a first set of images of the object among multiple images captured by the first camera, identifying a second set of images of the object among multiple images captured by a second camera, and generating at least one of a single image file and a single video file from a sequence of images comprising one or more of the first set of images and one or more of the second set of images.

### CROSS-REFERENCE TO RELATED APPLICATION

This application is a continuation-in-part of U.S. patent application Ser. No. 14/264,728, filed Apr. 29, 2014, titled “Systems and Methods for Secure Package Delivery,” the disclosure of which is hereby incorporated by reference in its entirety.

### BACKGROUND

The present disclosure, for example, relates to security and/or automation systems, and more particularly to images captured relative to a security and/or automation system.

Security and automation systems are widely deployed to provide various types of communication and functional features such as monitoring, communication, notification, and/or others. These systems may be capable of supporting communication with a user through a communication connection or a system management action.

Currently, a video may be captured by a security camera of a security and automation system located at a premises such as a home, school, or business. Upon being captured, the video file may be made available for playback. The recipient of the video file may manually select the video file for playback and watch the entire video or manually select which portions of the video file to view.

### SUMMARY

The disclosure herein includes methods and systems for improving security camera notifications, thereby improving the quality of information delivered by such notifications and improving a recipient's ability to respond in a timely manner to the information provided in such notifications.

A method for security and/or automation systems is described. In one embodiment, the method may include detecting, via a first camera at a premises, an object, identifying a first set of images of the object among multiple images captured by the first camera, identifying a second set of images of the object among multiple images captured by a second camera, and generating at least one of a single image file and a single video file from a sequence of images comprising one or more of the first set of images and one or more of the second set of images.

In some embodiments, detecting the object via the first camera may include detecting motion of the object by the first camera at a first time and analyzing an image of the object captured by the first camera. In some embodiments, the method may include determining the object is a delivery vehicle based at least in part on the analysis.

In some embodiments, the method may include detecting a first recognizable feature of the object based at least in part on the analyzing the image of the object captured by the first camera. In some cases, the first recognizable feature of the object may include at least one of a color of the object, a shape of the object, a sound made by the object, a relative size of the object, a human face of the object, a uniform of the object, an animal face of the object, a human body of the object, an animal body of the object, a logo on the object, an identifier on the object, an identification card, a signal emanating from the object, a vehicle, a type of vehicle, a delivery vehicle, a vehicle door, an open doorway of a delivery vehicle, a cargo door of a delivery vehicle, a headlight, a wheel, a grill cover, a windshield, or any combination thereof.

In some cases, detecting the object via the second camera may include detecting motion of the object by the second camera at a second time, the second time being after the first time and identifying a second recognizable feature of the object from an image of the object captured by the second camera. In some embodiments, the method may include comparing the first recognizable feature to the second recognizable feature.

In some embodiments, upon detecting a match between the first and second recognizable features, the method may include determining the object detected by the second camera is the same object detected by the first camera. In some cases, upon determining the object detected by the second camera is the same object detected by the first camera, the method may include selecting images of the object captured by the first camera and images of the object captured by the second camera and adding the selected images to the sequence of images in at least one of the single image file and the single video file. In some cases, the object may include at least one of a vehicle, a person, an animal, a delivery vehicle, a delivery person, a delivered package, or any combination thereof.

An apparatus for security and/or automation systems is also described. In one embodiment, the apparatus may include a processor, memory in electronic communication with the processor, and instructions stored in the memory, the instructions being executable by the processor to perform the steps of detecting, via a first camera at a premises, an object, identifying a first set of images of the object among multiple images captured by the first camera, identifying a second set of images of the object among multiple images captured by a second camera, and generating at least one of a single image file and a single video file from a sequence of images comprising one or more of the first set of images and one or more of the second set of images.

A non-transitory computer-readable medium is also described. The non-transitory computer readable medium may store computer-executable code, the code being executable by a processor to perform the steps of detecting, via a first camera at a premises, an object, identifying a first set of images of the object among multiple images captured by the first camera, identifying a second set of images of the object among multiple images captured by a second camera, and generating at least one of a single image file and a single video file from a sequence of images comprising one or more of the first set of images and one or more of the second set of images.

The foregoing has outlined rather broadly the features and technical advantages of examples according to this disclosure so that the following detailed description may be better understood. Additional features and advantages will be described below. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein—including their organization and method of operation—together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following a first reference label with a dash and a second label that may distinguish among the similar components. However, features discussed for various components—including those having a dash and a second reference label—apply to other similar components. If only the first reference label is used in the specification, the description is applicable to any one of the similar components having the same first reference label irrespective of the second reference label.

FIG. 1 is a block diagram of an example of a security and/or automation system in accordance with various embodiments;

FIG. 2 shows a block diagram of a device relating to a security and/or an automation system, in accordance with various aspects of this disclosure;

FIG. 3 shows a block diagram of a device relating to a security and/or an automation system, in accordance with various aspects of this disclosure;

FIG. 4 shows a block diagram relating to a security and/or an automation system, in accordance with various aspects of this disclosure;

FIG. 5 shows a block diagram of a data flow relating to a security and/or an automation system, in accordance with various aspects of this disclosure;

FIG. 6A shows a block diagram of environment relating to a security and/or an automation system, in accordance with various aspects of this disclosure;

FIG. 6B shows a block diagram of environment relating to a security and/or an automation system, in accordance with various aspects of this disclosure;

FIG. 7 is a flow chart illustrating an example of a method relating to a security and/or an automation system, in accordance with various aspects of this disclosure; and

FIG. 8 is a flow chart illustrating an example of a method relating to a security and/or an automation system, in accordance with various aspects of this disclosure.

### DETAILED DESCRIPTION

The following relates generally to automation and/or security systems. Automation systems may include one or more sensors located at certain locations of a premises. For example, sensors located relative to an entrance of the premises may include a camera sensor of a doorbell camera or security camera, a motion sensor, a proximity sensor, and/or an audio sensor, among others.

When an automation system at a premises includes multiple security cameras and one of the cameras is triggered, an occupant of the premises may receive a notification. The notification may provide information regarding the triggering event. In some cases, the notification may include a link to video captured in relation to the triggering event. Additionally, or alternatively, video captured in relation to the triggering event may be embedded in the notification. In some cases, two or more cameras at the premises may be triggered. Accordingly, the occupant may receive two or more separate notifications. Accordingly, the occupant may have to click through multiple notifications to view multiple videos captured in relation to the same triggering event.

The present systems and methods may relate to improving the response of multiple security cameras detecting one or more triggering events. In one embodiment of the present systems and methods, a first security camera at a premises may detect a triggering event. A second security camera at the premises may detect the same triggering event before, after, and/or while the first security camera detects the triggering event. In one embodiment, detecting the triggering event may include detecting motion of an object, recognizing a predetermined object in view of the respective security camera, or any combination thereof. In some embodiments, an automation system associated with the first and second security cameras may analyze one or more images captured by the first and second security cameras. For example, a control panel of the automation system may analyze one or more of the images. The captured images may include photographic images, video images, or any combination thereof. In one embodiment, the automation system may detect an object in images captured by the first and/or second security cameras. In some cases, the automation system may select one or more images of the object captured by the first security camera, select one or more images of the object captured by the second security camera, and digitally join the selected images from the first and second security cameras together.

In one embodiment, the automation system may identify an initial time associated with the triggering event and perform a search of images of the object that are captured by the first and second camera within a predetermined time period associated with the identified initial time. For example, the automation system may identify an initial time of 3:27 PM associated with the first known detection of the triggering event. Accordingly, the automation system may perform a search of images of the object captured by the first and/or second camera relative to the initial time of 3:27 PM. For example, the automation system may search for images of the object captured by the first and/or second camera up to 10 minutes before the initial time, or a search of images that include the object that are captured by either camera from 3:17 PM to 3:27 PM. Similarly, the automation system may search for images of the object captured by either camera from the initial time 3:27 PM to 3:37 PM. In one embodiment, the automation system may perform a first search of images captured within a first time period before the initial time of detection and perform a second search of images captured with a second time period after the initial time of detection. For example, the automation system may search for images of the object captured from the initial time of detection up to 15 minutes after the initial time as one example, and search for images of the object captured up to 5 minutes before the initial time, as one example.

In one embodiment, joining the selected images together may include generating a single image from one or more of the selected images from the first security camera and one or more of the selected images from the second security camera in the same single image. Additionally or alternatively, joining the selected images together may include generating a slideshow from one or more of the selected images from the first security camera and one or more of the selected images from the second security camera. Additionally or alternatively, joining the selected images together may include generating a single video file from one or more of the selected images from the first security camera and one or more of the selected images from the second security camera joined together into the same single video file.

Additionally or alternatively, the first security camera may identify images of the object and send one or more images that include the object to a control panel of the automation system. Likewise, the second security camera may identify images of the object and send one or more images that include the object to the control panel automation system. In some cases, the second security camera may identify images of the object and send one or more images that include the object to the first security camera. Additionally or alternatively, the first security camera may identify images of the object and send one or more images that include the object to the second security camera. In some cases, the first and/or second security camera may digitally join the selected images from the first and second security cameras together as described herein.

In one embodiment, upon digitally joining the selected images from the first and second security cameras together, the present systems and methods may generate a notification relative to the selected images from the first and second security cameras being joined together as described. For example, in one embodiment, the automation system may generate a notification relative to the digitally joined images. Additionally or alternatively, the first and/or second security camera may generate a notification relative to the digitally joined images. In some cases, the notification may include a link to the digitally joined images. In some cases, the digitally joined images may be embedded in the notification. For example, a movie that includes the combination of selected images from the first and second security camera may be embedded in the notification. For instance, a movie file may be attached to an email message and/or a text message. In some cases, the notification may include a proprietary message generated by and sent within the automation system. For example, a control panel of the automation system may send the notification to a device connected to the automation system such as a control panel display, a computing device, a television, or any combination thereof connected to the automation system.

In some embodiments, the automation system may provide a live feed from the first and second security cameras based on a real-time detection of the object. For example, the automation system may determine in real-time when the first security camera is detecting the object and when the second security camera is detecting the object and provide a live feed from either camera as the object is being detected. In some cases, the live feed may be provided to a local device within the premises, a device connected by wire or wirelessly to the automation system, a device that is remote from the premises such as a mobile computing device, or any combination thereof. When both cameras are detecting the object, the automation system may select a feed from one of the cameras based on analysis of the live feed of images and provide the selected feed based on the analysis. For example, the automation system may determine which of the cameras is providing a preferred view of the object such as a front view of the object being preferred over a rear view of the object, a full view of the object being preferred over a partial view of the object, or any combination thereof. Alternatively, when both cameras are detecting the object, the automation system may provide both feeds in a split screen format when both cameras are detecting the object, provide the feed of one of the cameras when only one camera is detecting the object, and provide a notification when either camera is no longer detecting the object.

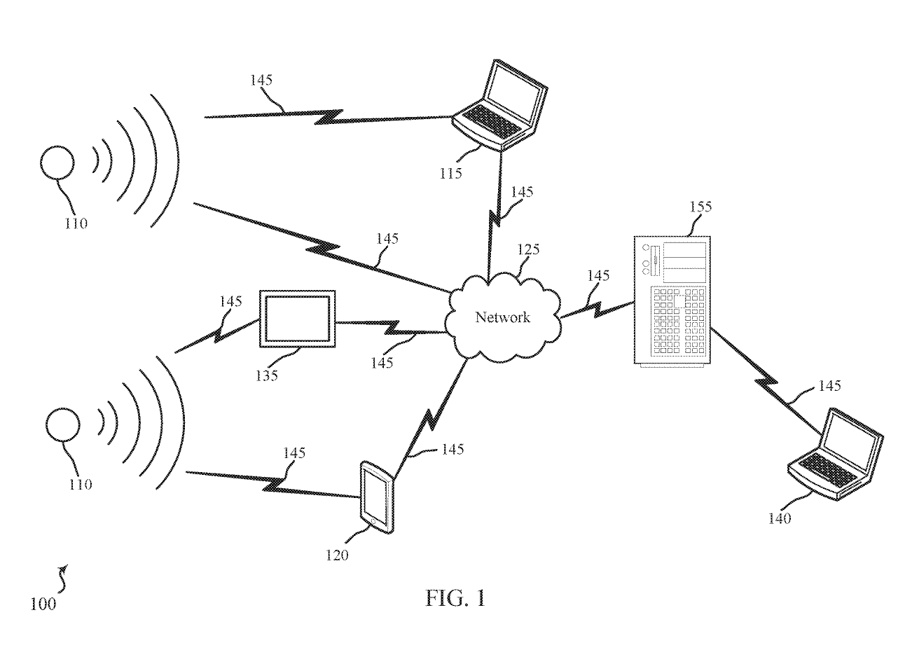

FIG. 1 is an example of a communications system 100 in accordance with various aspects of the disclosure. In some embodiments, the communications system 100 may include one or more sensor units 110, local computing device 115, 120, network 125, server 155, control panel 135, and remote computing device 140. One or more sensor units 110 may communicate via wired or wireless communication links 145 with one or more of the local computing device 115, 120 or network 125. The network 125 may communicate via wired or wireless communication links 145 with the control panel 135 and the remote computing device 140 via server 155. In alternate embodiments, the network 125 may be integrated with any one of the local computing device 115, 120, server 155, and/or remote computing device 140, such that separate components are not required.

Local computing device 115, 120 and remote computing device 140 may be custom computing entities configured to interact with sensor units 110 via network 125, and in some embodiments, via server 155. In other embodiments, local computing device 115, 120 and remote computing device 140 may be general purpose computing entities such as a personal computing device, for example, a desktop computer, a laptop computer, a netbook, a tablet personal computer (PC), a control panel, an indicator panel, a multi-site dashboard, an IPOD®, an IPAD®, a smart phone, a mobile phone, a personal digital assistant (PDA), and/or any other suitable device operable to send and receive signals, store and retrieve data, and/or execute modules.

Control panel 135 may be a smart home system panel, for example, an interactive panel mounted on a wall in a user's home. Control panel 135 may be in direct communication via wired or wireless communication links 145 with the one or more sensor units 110, or may receive sensor data from the one or more sensor units 110 via local computing devices 115, 120 and network 125, or may receive data via remote computing device 140, server 155, and network 125.

The local computing devices 115, 120 may include memory, at least one processor, an output, a data input and a communication module. The processor may be a general purpose processor, a Field Programmable Gate Array (FPGA), an Application Specific Integrated Circuit (ASIC), a Digital Signal Processor (DSP), and/or the like. The processor may be configured to retrieve data from and/or write data to the memory. The memory may be, for example, a random access memory (RAM), a memory buffer, a hard drive, a database, an erasable programmable read only memory (EPROM), an electrically erasable programmable read only memory (EEPROM), a read only memory (ROM), a flash memory, a hard disk, a floppy disk, cloud storage, and/or so forth. In some embodiments, the local computing devices 115, 120 may include one or more hardware-based modules (e.g., DSP, FPGA, ASIC) and/or software-based modules (e.g., a module of computer code stored at the memory and executed at the processor, a set of processor-readable instructions that may be stored at the memory and executed at the processor) associated with executing an application, such as, for example, receiving and displaying data from sensor units 110.

The processor of the local computing devices 115, 120 may be operable to control operation of the output of the local computing devices 115, 120. The output may be a television, a liquid crystal display (LCD) monitor, a cathode ray tube (CRT) monitor, speaker, tactile output device, and/or the like. In some embodiments, the output may be an integral component of the local computing devices 115, 120. Similarly stated, the output may be directly coupled to the processor. For example, the output may be the integral display of a tablet and/or smart phone. In some embodiments, an output module may include, for example, a High Definition Multimedia Interface™ (HDMI) connector, a Video Graphics Array (VGA) connector, a Universal Serial Bus™ (USB) connector, a tip, ring, sleeve (TRS) connector, and/or any other suitable connector operable to couple the local computing devices 115, 120 to the output.

The remote computing device 140 may be a computing entity operable to enable a remote user to monitor the output of the sensor units 110. The remote computing device 140 may be functionally and/or structurally similar to the local computing devices 115, 120 and may be operable to receive data streams from and/or send signals to at least one of the sensor units 110 via the network 125. The network 125 may be the Internet, an intranet, a personal area network, a local area network (LAN), a wide area network (WAN), a virtual network, a telecommunications network implemented as a wired network and/or wireless network, etc. The remote computing device 140 may receive and/or send signals over the network 125 via wireless communication links 145 and server 155.

In some embodiments, the one or more sensor units 110 may be sensors configured to conduct periodic or ongoing automatic measurements related to audio and/or image data signals. Each sensor unit 110 may be capable of sensing multiple audio and/or image parameters, or alternatively, separate sensor units 110 may monitor separate audio and image parameters. For example, one sensor unit 110 may monitor audio (e.g., human voice, human footsteps, vehicle engine noise, vehicle door noise, etc.), while another sensor unit 110 (or, in some embodiments, the same sensor unit 110) may detect images (e.g., photo, video, motion detection, infrared, etc.).

Data gathered by the one or more sensor units 110 may be communicated to local computing device 115, 120, which may be, in some embodiments, a thermostat or other wall-mounted input/output smart home display. In other embodiments, local computing device 115, 120 may be a personal computer and/or smart phone. Where local computing device 115, 120 is a smart phone, the smart phone may have a dedicated application directed to collecting audio and/or video data and calculating object detection therefrom. The local computing device 115, 120 may process the data received from the one or more sensor units 110 to obtain a probability of an object within an area of a premises such as an object within a predetermined distance of an entrance to the premises as one example. In alternate embodiments, remote computing device 140 may process the data received from the one or more sensor units 110, via network 125 and server 155, to obtain a probability of detecting an object within the vicinity of an area of a premises, such as detecting a person at an entrance to the premises for example. Data transmission may occur via, for example, frequencies appropriate for a personal area network (such as BLUETOOTH® or IR communications) or local or wide area network frequencies such as radio frequencies specified by the IEEE 802.15.4 standard, among others.

In some embodiments, local computing device 115, 120 may communicate with remote computing device 140 or control panel 135 via network 125 and server 155. Examples of networks 125 include cloud networks, local area networks (LAN), wide area networks (WAN), virtual private networks (VPN), wireless networks (using 802.11, for example), and/or cellular networks (using 3G and/or LTE, for example), etc. In some configurations, the network 125 may include the Internet. In some embodiments, a user may access the functions of local computing device 115, 120 from remote computing device 140. For example, in some embodiments, remote computing device 140 may include a mobile application that interfaces with one or more functions of local computing device 115, 120.

The server 155 may be configured to communicate with the sensor units 110, the local computing devices 115, 120, the remote computing device 140 and control panel 135. The server 155 may perform additional processing on signals received from the sensor units 110 or local computing devices 115, 120, or may simply forward the received information to the remote computing device 140 and control panel 135.

Server 155 may be a computing device operable to receive data streams (e.g., from sensor units 110 and/or local computing device 115, 120 or remote computing device 140), store and/or process data, and/or transmit data and/or data summaries (e.g., to remote computing device 140). For example, server 155 may receive a stream of passive audio data from a sensor unit 110, a stream of active audio data from the same or a different sensor unit 110, a stream of image (e.g., photo and/or video) data from either the same or yet another sensor unit 110, and a stream of motion data from either the same or yet another sensor unit 110.

In some embodiments, server 155 may “pull” the data streams, e.g., by querying the sensor units 110, the local computing devices 115, 120, and/or the control panel 135. In some embodiments, the data streams may be “pushed” from the sensor units 110 and/or the local computing devices 115, 120 to the server 155. For example, the sensor units 110 and/or the local computing device 115, 120 may be configured to transmit data as it is generated by or entered into that device. In some instances, the sensor units 110 and/or the local computing devices 115, 120 may periodically transmit data (e.g., as a block of data or as one or more data points).

The server 155 may include a database (e.g., in memory and/or through a wired and/or a wireless connection) containing audio and/or video data received from the sensor units 110 and/or the local computing devices 115, 120. Additionally, as described in further detail herein, software (e.g., stored in memory) may be executed on a processor of the server 155. Such software (executed on the processor) may be operable to cause the server 155 to monitor, process, summarize, present, and/or send a signal associated with resource usage data.

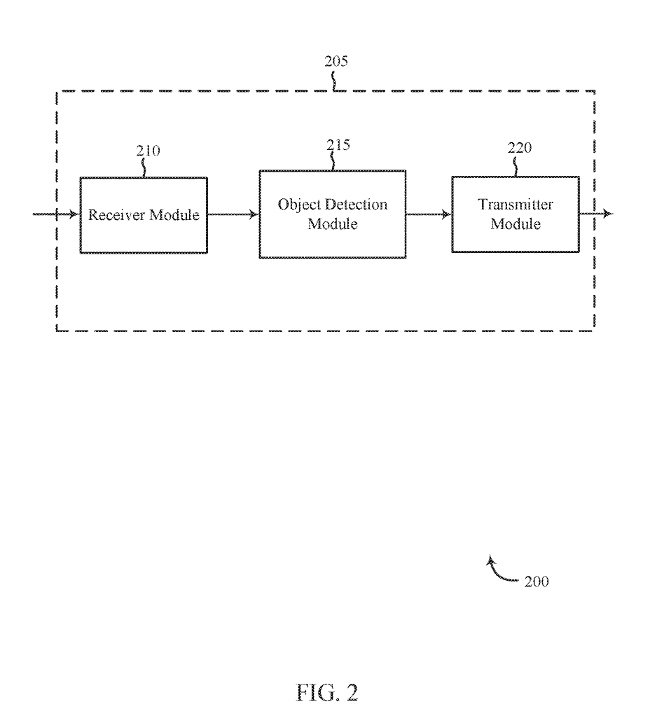

FIG. 2 shows a block diagram 200 of an apparatus 205 for use in electronic communication, in accordance with various aspects of this disclosure. The apparatus 205 may be an example of one or more aspects of a control panel 135 described with reference to FIG. 1. The apparatus 205 may include a receiver module 210, a object detection module 215, and/or a transmitter module 220. The apparatus 205 may also be or include a processor. Each of these modules may be in communication with each other and/or other modules—directly and/or indirectly.

The components of the apparatus 205 may, individually or collectively, be implemented using one or more application-specific integrated circuits (ASICs) adapted to perform some or all of the applicable functions in hardware. Alternatively, the functions may be performed by one or more other processing units (or cores), on one or more integrated circuits. In other examples, other types of integrated circuits may be used (e.g., Structured/Platform ASICs, Field Programmable Gate Arrays (FPGAs), and other Semi-Custom ICs), which may be programmed in any manner known in the art. The functions of each module may also be implemented—in whole or in part—with instructions embodied in memory formatted to be executed by one or more general and/or application-specific processors.

The receiver module 210 may receive information such as packets, user data, and/or control information associated with various information channels (e.g., control channels, data channels, etc.). The receiver module 210 may be configured to receive audio signals and/or data (e.g., human sounds, vehicle sounds, etc.) and/or image signals and/or data (e.g., images of a vehicle, images of a human, etc.). Information may be passed on to the object detection module 215, and to other components of the apparatus 205.

The object detection module 215 may be configured to identify an object detected by two or more image capturing devices located at a premises and to generate media files based on the images captured by the two or more image capturing devices.

The transmitter module 220 may transmit the one or more signals received from other components of the apparatus 205. The transmitter module 220 may transmit audio signals and/or data (e.g., vehicle sounds, human sounds, etc.) and/or image signals and/or data (e.g., images of vehicles, images of humans, etc.). In some cases, transmitter module 220 may transmit results of data analysis on at least one of image and audio signals and/or data analyzed by object detection module 215. In some examples, the transmitter module 220 may be collocated with the receiver module 210 in a transceiver module. In other examples, these elements may not be collocated.

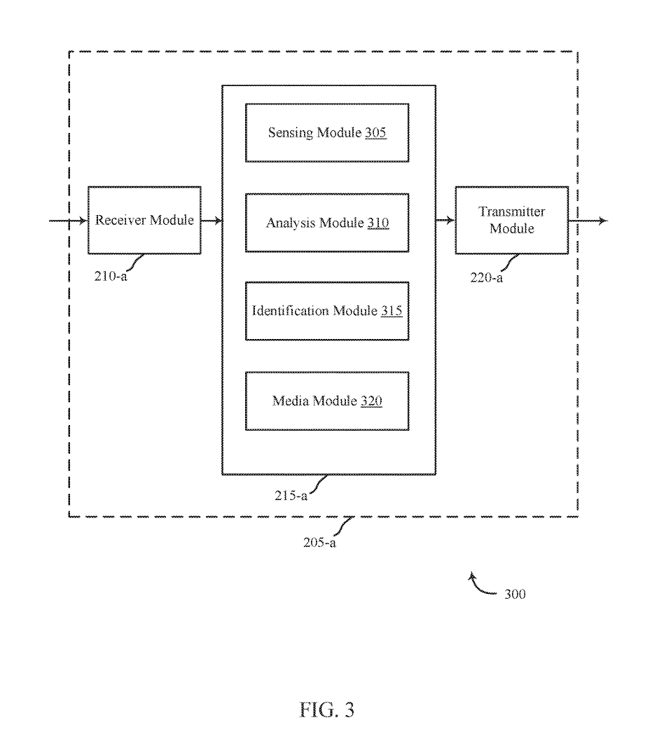

FIG. 3 shows a block diagram 300 of an apparatus 205-a for use in wireless communication, in accordance with various examples. The apparatus 205-a may be an example of one or more aspects of a control panel 135 described with reference to FIG. 1. It may also be an example of an apparatus 205 described with reference to FIG. 2. The apparatus 205-a may include a receiver module 210-a, a object detection module 215-a, and/or a transmitter module 220-a, which may be examples of the corresponding modules of apparatus 205. The apparatus 205-a may also include a processor. Each of these components may be in communication with each other. The object detection module 215-a may include sensing module 305, analysis module 310, identification module 315, and/or media module 320. The receiver module 210-a and the transmitter module 220-a may perform the functions of the receiver module 210 and the transmitter module 220, of FIG. 2, respectively.

The present systems and methods associated with object detection module 215 improve security camera notifications by sorting out camera events predetermined to be important camera events and sending the sorted data to a predetermined recipient such as an occupant of an associated premises. In some cases, at least a portion of object detection module 215 and/or components of object detection module 215 may be located in a first camera, a second camera, a third camera, etc. Additionally or alternatively, at least a portion of object detection module 215 and/or components of object detection module 215 may be located in one or more control panels, computing devices, etc. In some cases, object detection module 215 may include any combination of software, hardware, firmware, one or more sensors, one or more control panels, one or more hardware processors, one or more memory devices, one or more storage devices, instructions stored in the one or more memory devices and/or storage devices, and one or more computing devices, or any combination thereof.

In one embodiment, sensing module 305 may be configured to detect an object. In some cases, the object includes at least one of a vehicle, a person, an animal, a delivery vehicle, a delivery person, a delivered package, or any combination thereof. In some cases, sensing module 305 may detect an object in conjunction with a first camera. In some examples, the first camera may be located at a premises such as a home, workplace, school, or other type of building. In some embodiments, the first camera may be one camera among multiple cameras at the premises. For example, a first camera may be located at a first location, a second camera at a second location, a third camera at a third location, and so on. In some cases, at least one of the first camera and the second camera may include a doorbell camera. In some cases, one or more cameras may be located at an outside or outdoors location of a premises such as affixed to an external wall of a premises. Additionally or alternatively, one or more cameras may be located at an indoors or inside location of a premises such as affixed to an internal wall of a premises. In some cases, a camera mounted indoors may be positioned to captured a view outside a window of the premises. As one example, the first camera or the second camera may include a doorbell camera at the premises such as a doorbell camera near a door of the premises such as a front door and/or a rear door, etc.

In one embodiment, sensing module 305 may be configured to detect motion of the object in conjunction with the first camera. For example, sensing module 305 may include a motion detector that detects motion of the object. In some cases, sensing module 305 may compare one or more images captured by the first camera to detect the motion of the object. For example, sensing module 305 may detect a feature of the object in a first image captured by the first camera and detect the same feature of the object in a second image captured by the first camera and determine the object is moving based on the relative position of the object and/or the detected feature of the object in the first and second images.

In one embodiment, sensing module 305 may detect motion of the object by a second camera. In some embodiments, sensing module 305 may detect the object via the first camera at a first time. In some embodiments, sensing module 305 may detect the object via the second camera at a second time, where the second time is after the first time.

In one embodiment, analysis module 310 may be configured to analyze an image of an object captured by a camera. For example, analysis module 310 may be configured to analyze one or more images of an object captured by a first camera. In some cases, analysis module 310 may be configured to analyze one or more images of an object captured by a second camera. In some embodiments, analysis module 310 may be configured to analyze one or more images of an object captured by a first camera in relation to one or more images of the object captured by a second camera. In some cases, analysis module 310 may be configured to determine whether an object detected by one or more cameras is a predetermined object. For example, analysis module 310 may be configured to determine whether a detected object is a delivery vehicle based at least in part on the analysis. As another example, analysis module 310 may be configured to determine whether a detected object is a delivery person based at least in part on the analysis. In some cases, analysis module 310 may be configured to determine whether a detected object matches an object listed on a list of objects. As one example, the list of objects may include a delivery truck, a delivery person, a human, an animal, a certain person, a certain animal or pet, a certain make and model of a vehicle, a license plate of a vehicle, etc.

In one embodiment, identification module 315 may be configured to identify a first set of images of the object among multiple images captured by the first camera. For example, based at least in part on the analysis of images performed by analysis module 310, identification module 315 may identify among a set of images a subset of images that include a particular object and a subset of images that do not include the particular object. Similarly, identification module 315 may identify a second set of images of the object among multiple images captured by a second camera. In some cases, the first set of images may include at least one image of a delivery vehicle. Similarly, the second set of images may include at least one image of the same delivery vehicle. In some cases, identifying a first set of images of the object may include selecting a first set of one or more images captured by the first camera in which the delivery vehicle appears. Similarly, identifying a second set of images of the object may include selecting a second set of one or more images captured by the second camera in which the delivery vehicle appears.

In some embodiments, upon detecting the object by a first camera, analysis module 310 may perform a search for images of the objects captured by at least a second camera. In some cases, analysis module 310 may perform a search for images of the object captured by one or more additional camera within a predetermined time period in relation to the time the first camera detected the object. As one example, upon determining the first camera detects the object at 10:00 AM, analysis module 310 may analyze images captured by a second camera within a certain time period such as in the last five minutes from 9:55 AM to 10:00 AM. Additionally, or alternatively, upon determining the first camera detects the object at 3:00 PM, analysis module 310 may monitor images being captured by the second camera from 3:00 PM onward up to a certain predetermined time limit such as 10 minutes, from 3:00 PM to 3:10 PM as one example, to determine whether the second camera has or is capturing images of the object in relation to the first camera detecting the object. In some embodiments, upon detecting the object by a first camera, analysis module 310 may perform a search for images of the objects captured by the first camera before the time of detection. As one example, upon determining the first camera detects the object at 10:00 AM, analysis module 310 may analyze images captured by the first camera within a certain time period such as in the last five minutes from 9:55 AM to 10:00 AM.

In some embodiments, analysis module 310 may detect one or more features of the object in images captured by the first camera and detect one or more features of the object in images captured by the second camera, where the one or more features of the object detected by the second camera correspond to the one or more features of the object detected by the first camera. In some cases, at least one or both of the first and second cameras includes one or more processors to process captured images. As one example, at least one of the first and second cameras may include one or more image processors. In some cases, at least some imager processing may occur remotely from a camera. For example, images captured by a first camera may be processed at least partially at the first camera and/or processed at least partially at a device remote to the first camera such as a control panel communicatively connected to the first camera.

In one embodiment, analysis module 310 may analyze one or more images of an object captured by a first camera. Similarly, analysis module 310 may analyze one or more images of an object captured by a second camera. In some embodiments, identification module 315 may identify at least a first recognizable feature of the object captured in the one or more images captured by the first camera based at least in part on the analysis of the analysis module 310. In some embodiments, identification module 315 may identify at least the first recognizable feature of the object captured in the one or more images captured by the second camera based at least in part on the analysis of the analysis module 310.

In some cases, the at least first recognizable feature of the object may include at least one of a color of the object, a shape of the object, a sound made by the object, a relative size of the object, a human face of the object, a uniform of the object, an animal face of the object, a human body of the object, an animal body of the object, a logo on the object, an identifier on the object, an identification card, a signal emanating from the object, a vehicle, a type of vehicle, a delivery vehicle, a vehicle door, an open doorway of a delivery vehicle, a cargo door of a delivery vehicle, a headlight, a wheel, a grill cover, a windshield, or any combination thereof.

In some embodiments, identification module 315 may identify a first recognizable feature of an object from an image of the object captured by a first camera. In some embodiments, identification module 315 may identify a second recognizable feature of the object from an image of the object captured by a second camera. In some cases, analysis module 310 may compare the first recognizable feature to the second recognizable feature. Upon detecting a match between the first and second recognizable features, analysis module 310 may determine the object detected by the second camera is the same object detected by the first camera.

In one embodiment, media module 320 may generate at least one of a single image file and a single video file from a sequence of images. In some cases, the sequence of images include one or more images of the object captured by a first camera one or more images of the object captured by the second camera. Upon determining the object detected by the second camera is the same object detected by the first camera, media module 320 may select images of the object captured by the first camera and images of the object captured by the second camera. In some cases, media module 320 may combine selected images of the object captured by the first camera with selected images of the object captured by the second camera. In some cases, media module 320 may combine the selected images into a single image file and/or a single video file.

In some cases, media module 320 may stitch together images of the object captured by the first camera with images of the object captured by the second camera. In some cases, media module 320 may stitch images when at least one camera captures a certain number of images. For example, analysis module 310 may compare a number of images of the object captured by a particular camera to an image count threshold. When the number of images satisfy the image count threshold (e.g., the number of images exceed the threshold, or the number of images meet or exceed the threshold, etc.), then media module 320 may use at least some of those images when stitching together images into a single image-based file. As one example, a value of the image count threshold may be one or more images. As another example, with an image count threshold of 2 images, a first camera may capture 10 images of the object, a second camera may capture 1 image of the object, and a third camera may capture 3 images of the object. Accordingly, under this example, media module 320 may stitch together the images from the first with the images of the third, but not use any of the images from the second camera because the number of images captured by the second camera fails to satisfy the image count threshold.

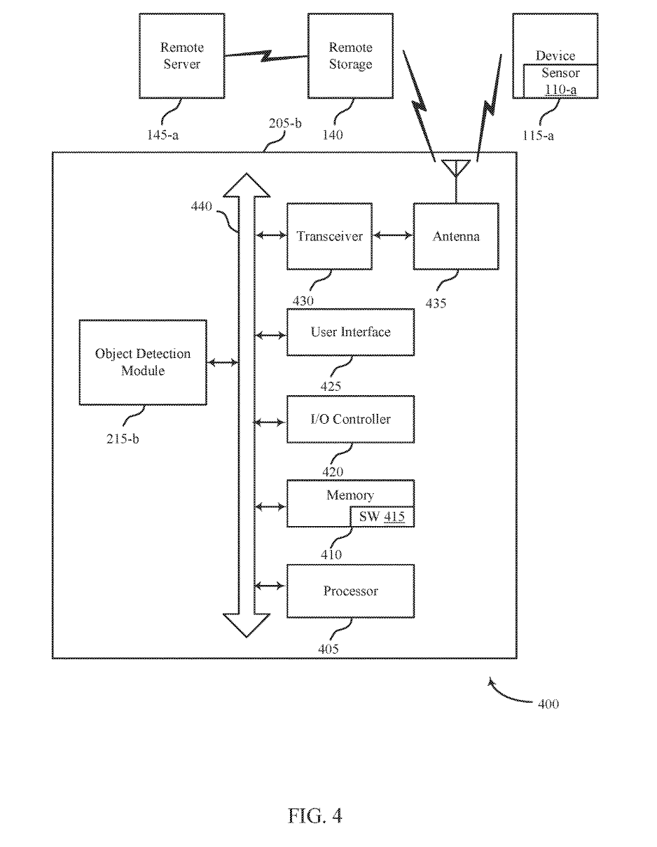

FIG. 4 shows a system 400 for use in automation systems, in accordance with various examples. System 400 may include an apparatus 205-b, which may be an example of the control panels 105 of FIG. 1. Apparatus 205-b may also be an example of one or more aspects of apparatus 205 and/or 205-a of FIGS. 2 and 3.

Apparatus 205-b may include components for bi-directional voice and data communications including components for transmitting communications and components for receiving communications. For example, apparatus 205-b may communicate bi-directionally with one or more of device 115-a, one or more sensors 110-a, remote storage 140, and/or remote server 145-a, which may be an example of the remote server of FIG. 1. This bi-directional communication may be direct (e.g., apparatus 205-b communicating directly with remote storage 140) and/or indirect (e.g., apparatus 205-b communicating indirectly with remote server 145-a through remote storage 140).

Apparatus 205-b may also include a processor module 405, and memory 410 (including software/firmware code (SW) 415), an input/output controller module 420, a user interface module 425, a transceiver module 430, and one or more antennas 435 each of which may communicate—directly or indirectly—with one another (e.g., via one or more buses 440). The transceiver module 430 may communicate bi-directionally—via the one or more antennas 435, wired links, and/or wireless links—with one or more networks or remote devices as described above. For example, the transceiver module 430 may communicate bi-directionally with one or more of device 115-a, remote storage 140, and/or remote server 145-a. The transceiver module 430 may include a modem to modulate the packets and provide the modulated packets to the one or more antennas 435 for transmission, and to demodulate packets received from the one 35, the control panel or the control device may also have multiple antennas 435 capable of concurrently transmitting or receiving multiple wired and/or wireless transmissions. In some embodiments, one element of apparatus 205-b (e.g., one or more antennas 435, transceiver module 430, etc.) may provide a direct connection to a remote server 145-a via a direct network link to the Internet via a POP (point of presence). In some embodiments, one element of apparatus 205-b (e.g., one or more antennas 435, transceiver module 430, etc.) may provide a connection using wireless techniques, including digital cellular telephone connection, Cellular Digital Packet Data (CDPD) connection, digital satellite data connection, and/or another connection.

The signals associated with system 400 may include wireless communication signals such as radio frequency, electromagnetics, local area network (LAN), wide area network (WAN), virtual private network (VPN), wireless network (using 802.11, for example), 345 MHz, Z-WAVE®, cellular network (using 3G and/or LTE, for example), and/or other signals. The one or more antennas 435 and/or transceiver module 430 may include or be related to, but are not limited to, WWAN (GSM, CDMA, and WCDMA), WLAN (including BLUETOOTH® and Wi-Fi), WMAN (WiMAX), antennas for mobile communications, antennas for Wireless Personal Area Network (WPAN) applications (including RFID and UWB). In some embodiments, each antenna 435 may receive signals or information specific and/or exclusive to itself. In other embodiments, each antenna 435 may receive signals or information not specific or exclusive to itself.

In some embodiments, one or more sensors 110-a (e.g., image, audio, motion, proximity, smoke, light, glass break, door, window, carbon monoxide, and/or another sensor) may connect to some element of system 400 via a network using one or more wired and/or wireless connections.

In some embodiments, the user interface module 425 may include an audio device, such as an external speaker system, an external display device such as a display screen, and/or an input device (e.g., remote control device interfaced with the user interface module 425 directly and/or through I/O controller module 420).

One or more buses 440 may allow data communication between one or more elements of apparatus 205-b (e.g., processor module 405, memory 410, I/O controller module 420, user interface module 425, etc.).

The memory 410 may include random access memory (RAM), read only memory (ROM), flash RAM, and/or other types. The memory 410 may store computer-readable, computer-executable software/firmware code 415 including instructions that, when executed, cause the processor module 405 to perform various functions described in this disclosure (e.g., image processing, object detection, and/or to determine whether to generate a notification based on processing and/or analysis, etc.). Alternatively, the software/firmware code 415 may not be directly executable by the processor module 405 but may cause a computer (e.g., when compiled and executed) to perform functions described herein. Alternatively, the computer-readable, computer-executable software/firmware code 415 may not be directly executable by the processor module 405 but may be configured to cause a computer (e.g., when compiled and executed) to perform functions described herein. The processor module 405 may include an intelligent hardware device, e.g., a central processing unit (CPU), a microcontroller, an application-specific integrated circuit (ASIC), etc.

In some embodiments, the memory 410 can contain, among other things, the Basic Input-Output system (BIOS) which may control basic hardware and/or software operation such as the interaction with peripheral components or devices. For example, the object detection module 215 to implement the present systems and methods may be stored within the system memory 410. Applications resident with system 400 are generally stored on and accessed via a non-transitory computer readable medium, such as a hard disk drive or other storage medium. Additionally, applications can be in the form of electronic signals modulated in accordance with the application and data communication technology when accessed via a network interface (e.g., transceiver module 430, one or more antennas 435, etc.).

Many other devices and/or subsystems may be connected to and/or included as one or more elements of system 400 (e.g., entertainment system, computing device, remote cameras, wireless key fob, wall mounted user interface device, cell radio module, battery, alarm siren, door lock, lighting system, thermostat, home appliance monitor, utility equipment monitor, and so on). In some embodiments, all of the elements shown in FIG. 4 need not be present to practice the present systems and methods. The devices and subsystems can be interconnected in different ways from that shown in FIG. 4. In some embodiments, an aspect of some operation of a system, such as that shown in FIG. 4, may be readily known in the art and are not discussed in detail in this application. Code to implement the present disclosure can be stored in a non-transitory computer-readable medium such as one or more of system memory 410 or other memory. The operating system provided on I/O controller module 420 may be iOS®, ANDROID®, MS-DOS®, MS-WINDOWS®, OS/2®, UNIX®, LINUX®, or another known operating system.

The transceiver module 430 may include a modem configured to modulate the packets and provide the modulated packets to the antennas 435 for transmission and/or to demodulate packets received from the antennas 435. While the control panel or control device (e.g., 205-b) may include a single antenna 435, the control panel or control device (e.g., 205-b) may have multiple antennas 435 capable of concurrently transmitting and/or receiving multiple wireless transmissions. The apparatus 205-b may include a object detection module 215-b, which may perform the functions described above for the object detection module 215 of apparatus 205 of FIGS. 2 and/or 3.

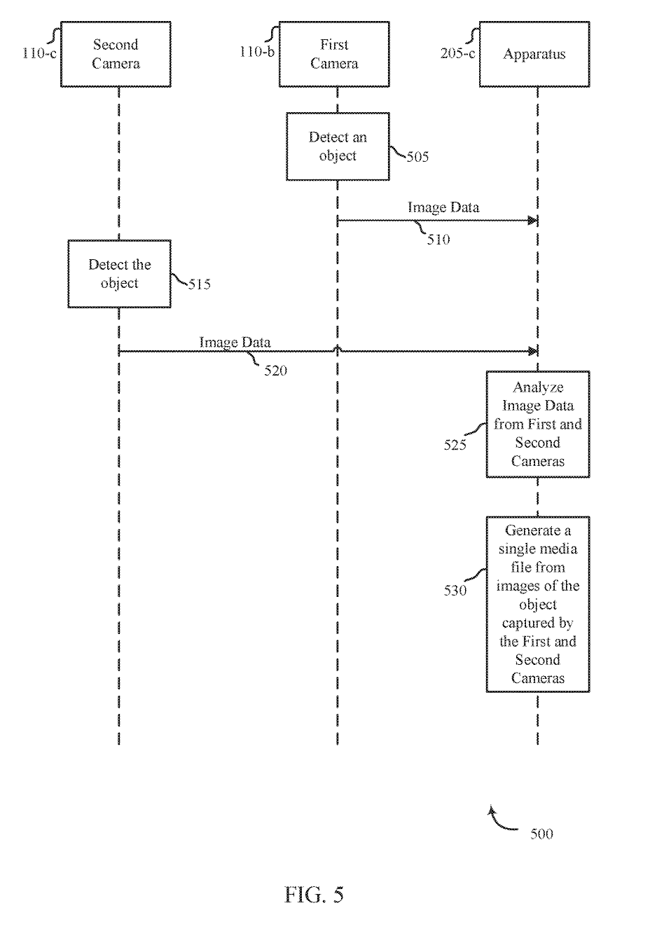

FIG. 5 shows a block diagram of a data flow 500 relating to a security and/or an automation system, in accordance with various aspects of this disclosure. The data flow 500 illustrates the flow of data between a first camera 110-b, a second camera 110-c, and an apparatus 205-c. The first and second cameras 110 may be examples of one or more aspects of sensor 110 from FIGS. 1 and/or 4. Apparatus 205-c may be an example of one or more aspects of control panel 135 of FIG. 1, and/or apparatus 205 of FIGS. 2-4. In some cases, apparatus 205-c may include a computing device such as a smart phone, desktop, laptop, remote server (e.g., server 155 of FIG. 1). In some cases, apparatus 205-c may include a storage device and/or database.

At block 505, first camera 110-b may detect an object. In some cases first camera 110-b may capture one or more images of the detected object. At 510, first camera 110-b may send image data to apparatus 205-c. In some cases, the image data sent by first camera 110-b may include at least one image of the detected object captured by first camera 110-b.

At block 515, second camera 110-c may detect the object. In some cases, second camera 110-c may capture one or more images of the object. At 520, second camera 110-c may send image data to apparatus 205-c. In some cases, the image data sent by second camera 110-c may include at least one image of the detected object captured by second camera 110-c.

At block 525, apparatus 205-c may analyze at least one of image data from first camera 110-b and image data from second camera 110-c. At block 530, apparatus 205-c may generate a single media file based at least in part on the analysis at block 525. In some cases, the single media file may include at least one image of the object captured by the first camera and/or at least one image of the object captured by the second camera. In some cases, the single media file may include a single image file such as a single Joint Photographic Experts Group (JPEG) image file, a single Portable Network Graphic (PNG) image file, etc. In some cases the single media file may include a single video file such as a Motion Picture Experts Group (MPEG) video file, an Audio Video Interleave (AVI) video file, MOV video file, etc.

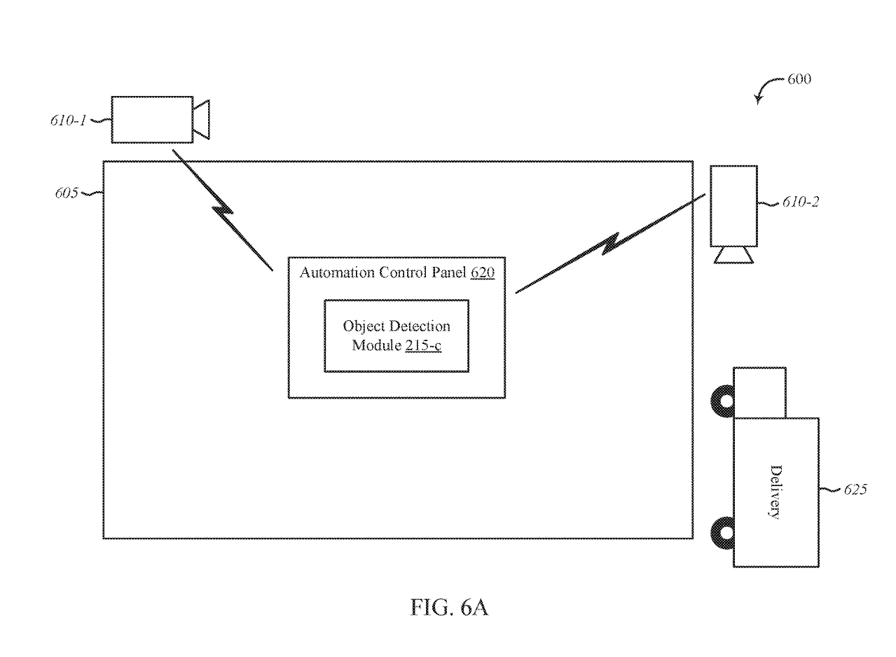

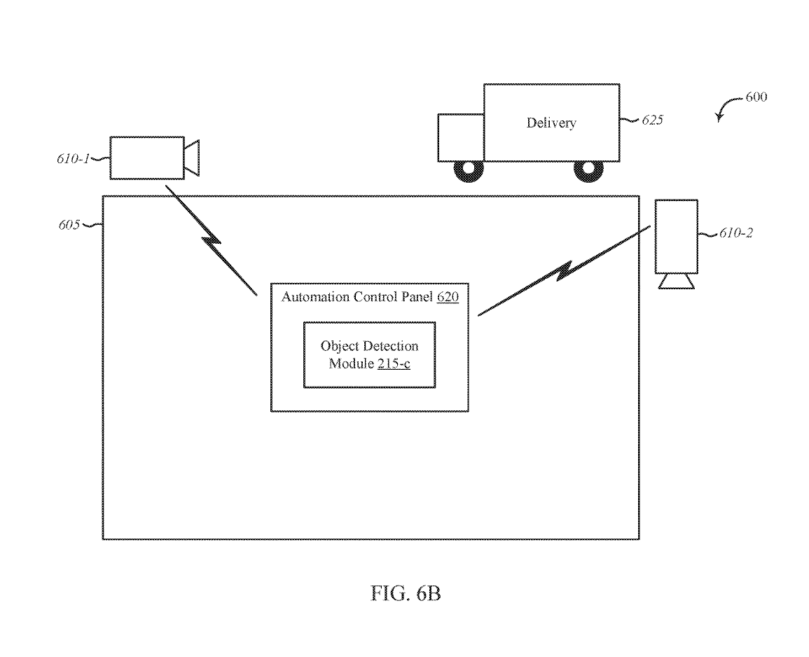

FIG. 6A shows a block diagram of an environment 600 relating to a security and/or an automation system, in accordance with various aspects of this disclosure. Environment 600 may include premises 605 and delivery vehicle 625. Premises 605 may include first camera 610-1, second camera 610-2, and automation control panel 620. First and second cameras 610 may include wired and/or wireless data transmission connections to automation control panel 620. Automation control panel 620 may include object detection module 215-c. The first and second cameras 610 may be examples of one or more aspects of sensor 110 from FIGS. 1, 4 and/or 5. Automation control panel 620 may be an example of one or more aspects of control panel 135 of FIG. 1, and/or apparatus 205 of FIGS. 2-5. In some cases, automation control panel 620 may include a computing device such as a smart phone, desktop, laptop, remote server (e.g., server 155 of FIG. 1). In some cases, automation control panel 620 may include a storage device and/or database.

In the illustrated example, first camera 610-1 may be located at a first location of premises 605 and second camera 610-2 may be located at a second location different from the first location of first camera 610-1. As shown, first camera 6100-1 may be positioned to have a first field of view, while second camera 610-1 may be positioned to have a second field of view different from the first field of view of first camera 610-1. Alternatively, first camera 610-1 and second camera 610-2 may be located at the same location, but first camera 610 may be pointed in a first direction and second camera 610-2 may be pointed in a second direction different from the first direction of first camera 610-1, resulting in second camera 610-2 having a different field of view than the field of view of first camera 610-1.

In one embodiment, environment 600 illustrates second camera 610-2 detecting delivery vehicle 625. In some cases, second camera 610-2 captures one or more images of delivery vehicle 625. In the illustrated example, when second camera 610-2 detects delivery vehicle 625, a positioning of first camera 610-1 prevents first camera 610-1 from detecting delivery vehicle 625. In some cases, second camera 610-2 may send to automation control panel 620 at least one of the one or more images captured of delivery vehicle 625.

In one embodiment, second camera 610-2 captures images that include delivery vehicle 625 in the images and captures images that do not include delivery vehicle 625. In some cases, second camera 610-2 identifies which images among multiple captured images include images of delivery vehicle 625 and sends only images of delivery vehicle 625 to automation control panel 620. Alternatively, second camera 610-2 sends to automation control panel 620 both images that includes delivery vehicle 625 and images that do not include delivery vehicle 625 and automation control panel 620 and automation control panel 620 identifies which images from second camera 610-2 include delivery vehicle 625.

FIG. 6B shows a block diagram of environment 600 relating to a security and/or an automation system, in accordance with various aspects of this disclosure. In one embodiment, environment 600 illustrates first camera 610-1 detecting delivery vehicle 625. In some cases, first camera 610-1 captures one or more images of delivery vehicle 625. In the illustrated example, when first camera 610-1 detects delivery vehicle 625, a positioning of second camera 610-2 prevents second camera 610-2 from detecting delivery vehicle 625. In some cases, first camera 610-1 may send to automation control panel 620 at least one of the one or more images captured of delivery vehicle 625.

In one embodiment, first camera 610-1 captures images that include delivery vehicle 625 in the images and captures images that do not include delivery vehicle 625. In some cases, first camera 610-1 identifies which images among multiple captured images include images of delivery vehicle 625 and sends only images of delivery vehicle 625 to automation control panel 620. Alternatively, first camera 610-1 sends to automation control panel 620 both images that includes delivery vehicle 625 and images that do not include delivery vehicle 625 and automation control panel 620 and automation control panel 620 identifies which images from first camera 610-1 include delivery vehicle 625.

In some cases, automation control panel 620 may analyze, in conjunction with object detection module 215-c, one or more images received from first camera 610-1 and/or second camera 610-2. In some cases, automation control panel 620 may generate a single media file that includes images of delivery vehicle 625 captured by first camera 610-1 and/or second camera 610-2.

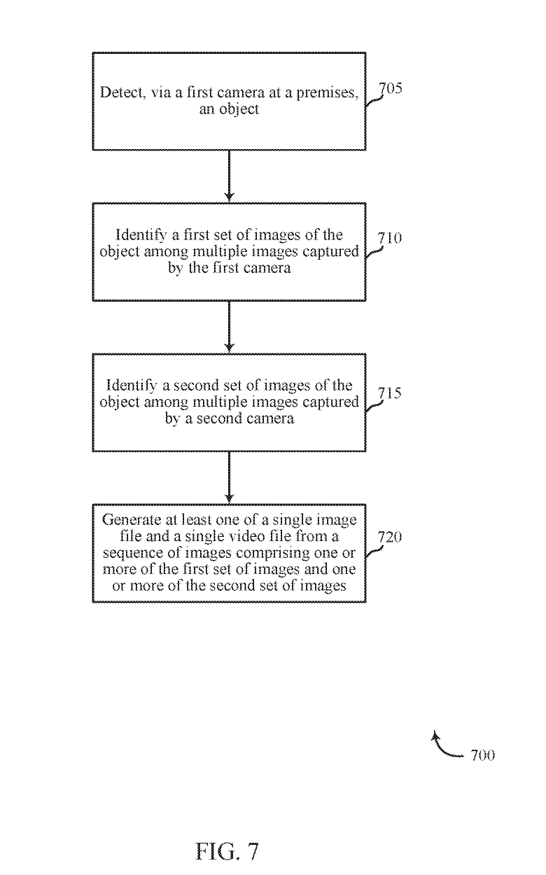

FIG. 7 is a flow chart illustrating an example of a method 700 for home automation, in accordance with various aspects of the present disclosure. For clarity, the method 700 is described below with reference to aspects of one or more of the sensor units 110 described with reference to FIGS. 1, 4, and/or 5. In some examples, a control panel, backend server, mobile computing device, and/or sensor may execute one or more sets of codes to control the functional elements of the control panel, backend server, mobile computing device, and/or sensor to perform one or more of the functions described below. Additionally or alternatively, the control panel, backend server, mobile computing device, and/or sensor may perform one or more of the functions described below using special-purpose hardware.

At block 705, method 700 may include detecting, via a first camera at a premises, an object. At block 710, method 700 may include identifying a first set of images of the object among multiple images captured by the first camera. At block 715, method 700 may include identifying a second set of images of the object among multiple images captured by a second camera. At block 720, method 700 may include generating at least one of a single image file and a single video file from a sequence of images comprising one or more of the first set of images and one or more of the second set of images. The operations at blocks 705-720 may be performed using the object detection module 215 described with reference to FIGS. 2-4 and/or another module.

Thus, the method 700 may provide for generating a single media file from multiple inputs in relation to automation/security systems. It should be noted that the method 700 is just one implementation and that the operations of the method 700 may be rearranged, omitted, and/or otherwise modified such that other implementations are possible and contemplated.

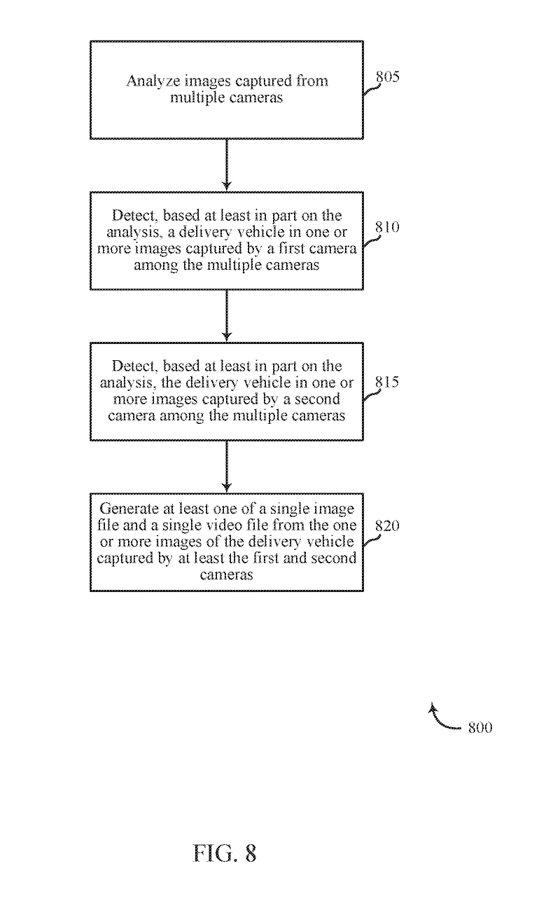

FIG. 8 is a flow chart illustrating an example of a method 800 for home automation, in accordance with various aspects of the present disclosure. For clarity, the method 800 is described below with reference to aspects of one or more of the sensor units 110 described with reference to FIGS. 1, 4, and/or 5. In some examples, a control panel, backend server, mobile computing device, and/or sensor may execute one or more sets of codes to control the functional elements of the control panel, backend server, mobile computing device, and/or sensor to perform one or more of the functions described below. Additionally or alternatively, the control panel, backend server, mobile computing device, and/or sensor may perform one or more of the functions described below using special-purpose hardware.

At block 805, method 800 may include analyzing images captured from multiple cameras. At block 810, method 800 may include detecting, based at least in part on the analysis, a delivery vehicle in one or more images captured by a first camera among the multiple cameras. At block 815, method 800 may include detecting, based at least in part on the analysis, the delivery vehicle in one or more images captured by a second camera among the multiple cameras. At block 820, method 800 may include generating at least one of a single image file and a single video file from the one or more images of the delivery vehicle captured by at least the first and second cameras. The operations at blocks 805-820 may be performed using the object detection module 215 described with reference to FIGS. 2-4 and/or another module.

Thus, the method 800 may provide for capturing images of a delivery vehicle from multiple cameras and generating a single media file from the images captured from the multiple cameras in relation to automation/security systems. It should be noted that the method 800 is just one implementation and that the operations of the method 800 may be rearranged, omitted, and/or otherwise modified such that other implementations are possible and contemplated.

In some examples, aspects from two or more of the methods 700 and 800 may be combined and/or separated. It should be noted that the methods 700 and 800 are just example implementations, and that the operations of the methods 700 and 800 may be rearranged or otherwise modified such that other implementations are possible.

The detailed description set forth above in connection with the appended drawings describes examples and does not represent the only instances that may be implemented or that are within the scope of the claims. The terms “example” and “exemplary,” when used in this description, mean “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and components described in connection with this disclosure may be implemented or performed with a general-purpose processor, a digital signal processor (DSP), an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, and/or state machine. A processor may also be implemented as a combination of computing devices, e.g., a combination of a DSP and a microprocessor, multiple microprocessors, one or more microprocessors in conjunction with a DSP core, and/or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items (for example, a list of items prefaced by a phrase such as “at least one of” or “one or more of”) indicates a disjunctive list such that, for example, a list of “at least one of A, B, or C” means A or B or C or AB or AC or BC or ABC (i.e., A and B and C).

In addition, any disclosure of components contained within other components or separate from other components should be considered exemplary because multiple other architectures may potentially be implemented to achieve the same functionality, including incorporating all, most, and/or some elements as part of one or more unitary structures and/or separate structures.

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, flash memory, CD-ROM, DVD, or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed.

This disclosure may specifically apply to security system applications. This disclosure may specifically apply to automation system applications. In some embodiments, the concepts, the technical descriptions, the features, the methods, the ideas, and/or the descriptions may specifically apply to security and/or automation system applications. Distinct advantages of such systems for these specific applications are apparent from this disclosure.

The process parameters, actions, and steps described and/or illustrated in this disclosure are given by way of example only and can be varied as desired. For example, while the steps illustrated and/or described may be shown or discussed in a particular order, these steps do not necessarily need to be performed in the order illustrated or discussed. The various exemplary methods described and/or illustrated here may also omit one or more of the steps described or illustrated here or include additional steps in addition to those disclosed.

Furthermore, while various embodiments have been described and/or illustrated here in the context of fully functional computing systems, one or more of these exemplary embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may permit and/or instruct a computing system to perform one or more of the exemplary embodiments disclosed here.

This description, for purposes of explanation, has been described with reference to specific embodiments. The illustrative discussions above, however, are not intended to be exhaustive or limit the present systems and methods to the precise forms discussed. Many modifications and variations are possible in view of the above teachings. The embodiments were chosen and described in order to explain the principles of the present systems and methods and their practical applications, to enable others skilled in the art to utilize the present systems, apparatus, and methods and various embodiments with various modifications as may be suited to the particular use contemplated.

What is claimed is:

1. A method for improving security camera notifications, comprising:
detecting, via a first camera at a premises, an object;
identifying a first set of images of the object among multiple images captured by the first camera;
identifying a second set of images of the object among multiple images captured by a second camera; and
generating at least one of a single image file and a single video file from a sequence of images comprising one or more of the first set of images and one or more of the second set of images.

2. The method of claim 1, detecting the object via the first camera comprising:
detecting motion of the object by the first camera at a first time; and
analyzing an image of the object captured by the first camera.

3. The method of claim 2, comprising:
determining the object is a delivery vehicle based at least in part on the analysis.

4. The method of claim 2, comprising:
detecting a first recognizable feature of the object based at least in part on the analyzing the image of the object captured by the first camera.

5. The method of claim 4, wherein the first recognizable feature of the object includes at least one of a color of the object, a shape of the object, a sound made by the object, a relative size of the object, a human face of the object, a uniform of the object, an animal face of the object, a human body of the object, an animal body of the object, a logo on the object, an identifier on the object, an identification card, a signal emanating from the object, a vehicle, a type of vehicle, a delivery vehicle, a vehicle door, an open doorway of a delivery vehicle, a cargo door of a delivery vehicle, a headlight, a wheel, a grill cover, a windshield, or any combination thereof.

6. The method of claim 4, detecting the object via the second camera comprising:
detecting motion of the object by the second camera at a second time, the second time being after the first time; and
identifying a second recognizable feature of the object from an image of the object captured by the second camera.

7. The method of claim 6, comprising:
comparing the first recognizable feature to the second recognizable feature.

8. The method of claim 8, comprising:
upon detecting a match between the first and second recognizable features, determining the object detected by the second camera is the same object detected by the first camera.

9. The method of claim 8, comprising:
upon determining the object detected by the second camera is the same object detected by the first camera, selecting images of the object captured by the first camera and images of the object captured by the second camera; and
adding the selected images to the sequence of images in at least one of the single image file and the single video file.

10. The method of claim 2, wherein the object includes at least one of a vehicle, a person, an animal, a delivery vehicle, a delivery person, a delivered package, or any combination thereof.

11. An apparatus for an automation system, comprising:
a processor;
memory in electronic communication with the processor; and
instructions stored in the memory, the instructions being executable by the processor to:
detect, via a first camera at a premises, an object;
identify a first set of images of the object among multiple images captured by the first camera;
identify a second set of images of the object among multiple images captured by a second camera; and
generate at least one of a single image file and a single video file from a sequence of images comprising one or more of the first set of images and one or more of the second set of images.

12. The apparatus of claim 11, the instructions being executable by the processor to:
detect motion of the object by the first camera at a first time; and
analyze an image of the object captured by the first camera.

13. The apparatus of claim 12, the instructions being executable by the processor to:
determine the object is a delivery vehicle based at least in part on the analysis.

14. The apparatus of claim 12, the instructions being executable by the processor to:
detect a first recognizable feature of the object based at least in part on the analyzing the image of the object captured by the first camera.

15. The apparatus of claim 14, wherein the first recognizable feature of the object includes at least one of a color of the object, a shape of the object, a sound made by the object, a relative size of the object, a human face of the object, a uniform of the object, an animal face of the object, a human body of the object, an animal body of the object, a logo on the object, an identifier on the object, an identification card, a signal emanating from the object, a vehicle, a type of vehicle, a delivery vehicle, a vehicle door, an open doorway of a delivery vehicle, a cargo door of a delivery vehicle, a headlight, a wheel, a grill cover, a windshield, or any combination thereof.

16. The apparatus of claim 14, the instructions being executable by the processor to:
detect motion of the object by the second camera at a second time, the second time being after the first time; and
identify a second recognizable feature of the object from an image of the object captured by the second camera.

17. The apparatus of claim 16, the instructions being executable by the processor to:
compare the first recognizable feature to the second recognizable feature.

18. The apparatus of claim 17, the instructions being executable by the processor to:
upon detecting a match between the first and second recognizable features, determine the object detected by the second camera is the same object detected by the first camera.

19. The apparatus of claim 18, the instructions being executable by the processor to:
upon determining the object detected by the second camera is the same object detected by the first camera, select images of the object captured by the first camera and images of the object captured by the second camera; and
add the selected images to the sequence of images in at least one of the single image file and the single video file.

20. A non-transitory computer-readable medium storing computer-executable code for an automation system, the code executable by a processor to:
detect, via a first camera at a premises, an object;
identify a first set of images of the object among multiple images captured by the first camera;
identify a second set of images of the object among multiple images captured by a second camera; and
generate at least one of a single image file and a single video file from a sequence of images comprising one or more of the first set of images and one or more of the second set of images.
